(19) United States
(12) Patent Application Publication
(10) Pub. No.: US 2010/0039562 A1
(43) Pub. Date: Feb. 18, 2010

(54) Source and output device-independent pixel compositor device adapted to incorporate the digital visual interface (DVI)

(75) Inventors: Ruigang Yang, Lexington, KY (US); Anselmo Lastra, Chapel Hill, NC (US)

Correspondence Address: JEAN M. MACHELEDT, 501 SKYSAIL LANE, SUITE B100, FORT COLLINS, CO, 80525-3133, US

(73) Assignees: University of Kentucky Research Foundation (UKRF), Lexington, KY (US); University of North Carolina, Chapel Hill, Chapell Hill, NC (US)

(21) Appl. No.: 12/384,965

(22) Filed: Apr. 9, 2009

Related U.S. Application Data
(60) Provisional application No. 61/123,529, filed on Apr. 9, 2008.

(51) Int. Cl. H04N 9/31; G09G 5/00; G09G 5/36; G06F 3/038; H04N 11/06

(52) U.S. Cl. 348/655; 345/672; 345/545; 345/214; 348/745; 348/E11.007; 348/E09.025

(57) ABSTRACT

A pixel compositor device for routing an incoming stream of pixel data having been rendered elsewhere and bound for being projected. The device includes a plurality of digital signal inputs each adapted for receiving a plurality of pixel information from the incoming stream of pixel data. The digital signal inputs are in communication with at least one buffer for the pixel information once received by the device. A processing unit is included for image warping the pixel information by performing, on each of a respective of the pixel information: (i) a mapping relating to location of the respective pixel information, and (ii) a scaling function. The geometric mapping can be performed by applying an interpolation technique; and the scaling function can be any of a number of photometric correction functions (alpha-blending, color uniformity correction, image brightness or contrast adjustment, etc.). Once an image warping has been performed on the respective pixel information, it is routed out of the device through one of several digital signal outputs. A system for routing pixel data is disclosed having two or more of the pixel compositor devices in communication with an image rendering cluster of units (as the source of the incoming stream of pixel data) and a plurality of projectors; as is a method for routing an incoming stream of pixel data having been rendered elsewhere and bound for being projected.

This application claims priority to pending U.S. provisional patent app. No. 61/123,529 filed 9 Apr. 2008 on behalf of the assignee hereof for the applicants hereof. To the extent consistent with the subject matter set forth herein, provisional app. No. 61/123,529 and its EXHIBITS are hereby fully incorporated, herein, by reference for background and full technical support.

The invention disclosed in this provisional application was made with United States government support awarded by the following agencies: U.S. Department of Homeland Security, 2005-2006 contract; and the National Science Foundation (NSF) award number IIS-0448185. Accordingly, the U.S. Government has rights in this invention.

### BACKGROUND OF THE INVENTION

### Field of the Invention

In general, the present invention relates to computer-implemented systems and techniques for interconnecting one or more video or motion-picture source devices (e.g., a personal computer, “PC”, or a DVD player) with a multitude of projection devices (projectors) and running graphics applications that produce three-dimensional (“3D”) displays (especially those consisting of composite images) onto a variety of surfaces.

### General Discussion of Technological Areas (by Way of Reference, Only)

### Historical Perspective:

Multi-projector, visually immersive displays have emerged as an important tool for a number of applications including scientific visualization, augmented reality, advanced teleconferencing, training, and simulation. Techniques have been developed that use one or more cameras to observe a given display setup in a more casual alignment, where projectors are only coarsely aligned. Using camera based feedback from the observed setup, the necessary adjustments needed to register the imagery, both in terms of geometry and color, can be automatically computed. In order to create seamless imagery in such a multiprojector display, the desired image (first-pass) has to be warped (second-pass) to “undo” the distortions caused by the projection process. To date, this has always been done employing highly-specialized software applications. The second rendering pass, while not significant, does cause some overhead. In addition, applications designed for regular displays usually have to be modified in the source code level to take advantage of the large display capability. In contrast, abutted displays (mechanically aligned projectors with no overlap)—while this takes days or weeks to setup—can largely run any application without modification, by utilizing the widely available multi-channel output found in consumer-grade PCs. This has been one of the most significant disadvantages of displays with overlaps.

General Background Materials: EXHIBITS A, B, C, D, and E were each identified, filed, and incorporated into applicants' provisional app. 61/123,529: (A) Digital Visual Interface-Wikipedia, on-line encyclopedia, reprinted from the internet at en.wikipedia.org/wiki/Digital_Visual_Interface; (B) X. Cavin, C. Mion, and A. Filbois, “Cots cluster-based sort-last rendering: Performance evaluation and pipelined implementation,” In Proceedings of IEEE Visualization, pages 15-23, 2005; (C) G. Stoll, M. Eldridge, D. Patterson, A. Webb, S. Berman, R. Levy, C. Caywood, M. Taveira, S. Hunt, and P. Hanrahan, “Lightning-2: a high-performance display subsystem for pc clusters,” In Proceedings of SIGGRAPH 2001, pages 141-148, 2001; (D) HDVG-Hi-Def Graphical Computer, 2-pg brochure reprinted (www.orad.co.il); and (E) B. Raffin and Luciano Soares, “PC Clusters for Virtual Reality,” Proceedings of the IEEE Virtual Reality Conference (VR'06), IEEE 1087-8270/06 (2006).

Dedicated video compositing hardware currently exists. Examples include the Lightning-2 system, see EXHIBIT C hereof (Stoll et al. (2001)), and the commercially available HDVG system, see EXHIBIT D hereof (printed from www.orad.co.il). However, the Stoll et al. (2001) and HDVG (www.orad.co.il) systems are both limited to performing conventional compositing tasks in which each video stream is restricted to a rectilinear region in the final output, i.e., the routing is limited to block transfer of pixels. None of the current systems provide the flexibility of the new pixel comparator device disclosed herein. While specialized digital projectors currently do exist with some functionality to perform simple piecewise linear warp to the input image content, such known projectors are only hardwired to allow one input per projector unit; thus, for a conventional projector unit to accept input digital pixel information from more than one input (image source/device), additional separate video scaling and splitting hardware must be used with the conventional projector. Further, the limited nature of conventional specialized projectors make them unavailable for direct tie-into a multi-projector display that has overlaps, since one projector would need part of the images from its neighborhood in the overlap region.

Unlike conventional projector systems, the unique hardware platform, with it's uniquely connected system of components, combines two key functionalities, namely, pixel distribution (geometric mapping) and photometric warping (pixel intensity, color/frequency), into a single physical compositor device 10, 100, FIGS. 1A-1B. Secondly and further unique, is the functionality offered by the new compositor device of the invention, to perform pixel distribution (geometric mapping) and photometric warping (pixel intensity, brightness, contrast, color/frequency) on a per-pixel basis. That is, the classic mapping and warping function capabilities of conventional digital projection hardware is very limited: Currently-available systems are created as dedicated complex systems that necessarily view motional images (digital video or film) bound for digital projection. The images are systematically partitioned by the rendering computers/computer cluster and information is transferred, accordingly. Thus, the conventional systems are only capable of simple overall scaling and translation of the image information on a large scale using global pixel warping based on a set of pre-defined, known parametric functions.

Distinctive from conventional hardware, the new pixel compositor device performs ‘arbitrary’ geometric mapping: A rendered image, once broken down to its very basic parts (a stream of pixels) is directed into one of a plurality of digital inputs of the device and manipulated therewithin on a per-pixel basis so that any of the pixels within an input stream may be routed out any of a plurality of digital outputs of the devices, i.e., mapping can be performed between any input pixel to any output pixel. Prior systems are limited to simple linear mapping. The per-pixel granularity offered by the new device of the invention allows much more flexibility as a retrofit for use in applications beyond multi-projector displays, such as in auto-stereoscopic (multiview) displays, in particular lenticular-based 3D displays (which display many views simultaneously, therefore, requiring orders of magnitude more pixels to provide an observer adequate resolution). Furthermore, images from the rendering nodes/computers typically have to be sliced and interleaved to form the proper composite image for display. None of the existing hardware used with conventional multi-projection systems can provide the level of image composition flexibility afforded by the instant invention; namely, to perform geometric mapping (location within the image) along with a photometric correction/scaling function (for adjustment of intensity, color/frequency) on a per-pixel basis. The level of flexibility afforded a system designer is further enhanced by the unique (per-pixel based) design of the invention, as several devices may be configured in communication to create a multi-tiered/layered pixel information routing bridge between the rendering computer (or cluster) and one or more projectors.

### DEFINITIONS

The DVI interface uses a digital protocol in which the desired illumination of pixels is transmitted as binary data. When the display is driven at its native resolution, it will read each number and apply that brightness to the appropriate pixel. In this way, each pixel in the output buffer of the source device corresponds directly to one pixel in the display device, whereas with an analog signal the appearance of each pixel may be affected by its adjacent pixels as well as by electrical noise and other forms of analog distortion. See Wikipedia, the on-line encyclopedia, reprinted from the webpage at en.wikipedia.org/wiki/Digital_Visual_Interface for further general discussion of the well known DVI interface.

A video projector uses video signals to project corresponding images onto a projection screen/surface using a lens system. A non-exhaustive list of various projection technologies:
CRT projector using cathode ray tubes. This typically involves a blue, a green, and a red tube.
LCD projector using LCD light gates: LCD projectors are quite common due to affordability; are often used for home theaters and businesses.
DLP projector uses one, two, or three microfabricated light valves called digital micromirror devices (DMDs). The single- and double-DMD versions use rotating color wheels in time with the mirror refreshes to modulate color.
LCOS projector uses Liquid crystal on silicon.
D-ILA JVC's Direct-drive Image Light Amplifier is based on LCOS technology.
LED an array of Light Emitting Diodes is used as the light source.

A graphics processing unit, GPU, also occasionally called visual processing unit, or VPU, is a dedicated graphics rendering device for a personal computer, workstation, or game console. Modern GPUs manipulate and display computer graphics. A GPU can sit on top of a video card, or it can be integrated directly into the motherboard. A vast majority of new desktop and notebook computers have integrated GPUs, which are usually less powerful than their add-in counterparts.

A GPU cluster is a cluster of computerized nodes, each equipped with a GPU. By harnessing the computational power of modern GPUs via General-Purpose Computing on Graphics Processing Units (GPGPU), a GPU cluster can perform fast calculations.

Compositing (as a technique used in film and video motion picture production) is the combining of visual elements from separate sources into single images, done to create an illusion that all the elements are of the same scene. One simple example is to record a digital video of an individual in front of a plain blue (or green) screen; digital compositing—i.e., digital assembly of multiple images to make a final image-replaces only the designated blue (or green) color pixels with a desired background (e.g., weather map). Software instructions control which of the pixels within a designated range of pixels is replaced with a pixel from another image; then the pixels are (re-)aligned for a desired visual appearance/affect.

Raster images are stored in a computer in the form of a grid of picture elements, or pixels. The collection of pixels contains information about the image's color and brightness information. Image editors are employed to change the pixels to enhance the image they, collectively, represent.

A voxel (volumetric and pixel) is a volume element, representing a value on a regular grid in three dimensional space. This is analogous to a pixel, which represents 2D image data. As with pixels, voxels themselves typically do not contain their position in space (their coordinates); but rather, it is inferred based on their position relative to other voxels (i.e., their position in the data structure that makes up a single volume image). A texel (i.e., texture element|pixel) is the fundamental unit of texture space, used in computer graphics. Textures are represented by arrays of texels, just as pictures are represented by arrays of pixels.

Texture mapping is the electronic equivalent of applying patterned paper to a plain ‘white’ 3D object. For example, take three squares, each covered randomly with a different graphic (say, a letter of the alphabet such as is found on a child's building block). The three ‘flat’ digitally-produced images of the three letters can be directly mapped (using texture mapping) onto the three visible facets of a 3D digitally generated cube. ATTACHMENT 01 hereof consists of six pages authored by an applicant in 2005 summarizing a technique known as backward mapping (or, inverse mapping) used in texture mapping to create a 2D image from 3D data. Because a texel (i.e., the smallest graphical element in a texture map) does not correspond exactly to a screen pixel, to map the texels to the screen, a filter computation must be applied.

A mask is data that is used for bitwise or per-pixel operations. When a given image is intended to be placed over a background, the transparent areas can be specified through a binary mask. Often an image has more than one bitmap.

Computerized Devices, Memory & Storage Devices/Media:

I. Digital computers. A processor is the set of logic devices/circuitry that responds to and processes instructions to drive a computerized device. The central processing unit (CPU) is considered the computing part of a digital or other type of computerized system. Often referred to simply as a processor, a CPU is made up of the control unit, program sequencer, and an arithmetic logic unit (ALU)—a high-speed circuit that does calculating and comparing. Numbers are transferred from memory into the ALU for calculation, and the results are sent back into memory. Alphanumeric data is sent from memory into the ALU for comparing. The CPUs of a computer may be contained on a single ‘chip’, often referred to as microprocessors because of their tiny physical size. As is well known, the basic elements of a simple computer include a CPU, clock and main memory; whereas a complete computer system requires the addition of control units, input, output and storage devices, as well as an operating system. The tiny devices referred to as ‘microprocessors’ typically contain the processing components of a CPU as integrated circuitry, along with associated bus interface. A microcontroller typically incorporates one or more microprocessor, memory, and I/O circuits as an integrated circuit (IC). Computer instruction(s) are used to trigger computations carried out by the CPU.

II. Computer Memory and Computer Readable Storage. While the word ‘memory’ has historically referred to that which is stored temporarily, with storage traditionally used to refer to a semi-permanent or permanent holding place for digital data—such as that entered by a user for holding long term—more-recently, the definitions of these terms have blurred. A non-exhaustive listing of well known computer readable storage device technologies are categorized here for reference: (1) magnetic tape technologies; (2) magnetic disk technologies include floppy disk/diskettes, fixed hard disks (often in desktops, laptops, workstations, etc.), (3) solid-state disk (SSD) technology including DRAM and ‘flash memory’; and (4) optical disk technology, including magneto-optical disks, PD, CD-ROM, CD-R, CD-RW, DVD-ROM, DVD-R, DVD-RAM, WORM, OROM, holographic, solid state optical disk technology, and so on.

### SUMMARY OF THE INVENTION

Briefly described, in one characterization, the invention is directed to a unique pixel compositor device for routing an incoming stream of pixel data having been rendered elsewhere and bound for being projected. The device includes a plurality of digital signal inputs each adapted for receiving a plurality of pixel information from the incoming stream of pixel data. The digital signal inputs are in communication with at least one buffer providing temporary storage for the pixel information once received by the device. A processing unit is included for image warping the pixel information by performing, on each of a respective of the pixel information: (i) a mapping relating to location of the respective pixel information, and (ii) a scaling function. The geometric mapping can be performed by applying any of a number of suitable interpolation techniques (nearest-neighbor interpolation, bilinear interpolation, trilinear interpolation, and so on) and the scaling function can be any of a number of known photometric correction functions (alpha-blending, typically carried out by applying a per-pixel scale factor to each respective pixel information, color uniformity correction, image brightness or contrast adjustment, and so on). Once an image warping has been performed on the respective pixel information, it is routed out of the device through one of several digital signal outputs. A system for routing pixel data is also disclosed having two or more of the pixel compositor devices in communication with an image rendering cluster of computerized units (the source of the incoming stream of pixel data) and a plurality of projectors; as is a method for routing an incoming stream of pixel data having been rendered elsewhere and bound for being projected.

### BRIEF DESCRIPTION OF DRAWINGS

For purposes of illustrating the innovative nature plus the flexibility of design and versatility of the new system and associated technique, the figures are included. Certain background materials, each labeled an “EXHIBIT” and attached to applicants' provisional app. No. 61/123,529 to which priority has been claimed hereby—EXHIBITS A, B, C, D, and E—were authored by others. Each of these EXHIBITS is hereby incorporated herein by reference for purposes of providing general background technical information to the extent consistent with the technical discussion, herein. One can readily appreciate the advantages as well as novel features that distinguish the instant invention from conventional computer-implemented 3D compositing devices. Where similar components are represented in different figures or views, an effort has been made to use the same/similar reference numbers for purposes of consistency. The figures as well as any incorporated technical materials have been included to communicate the features of applicants' innovation by way of example, only, and are in no way intended to limit the disclosure hereof.

FIG. 1A is a high-level schematic depicting features of a pixel compositor device 10.

FIG. 1B is a block diagram detailing components of an alternative preferred device 100 of the pixel compositor device 10, represented in FIG. 1A. The data flow through compositor 100 is depicted in a diagram FIG. 4, 400.

FIG. 2 is a high-level schematic depicting features of a preferred system 200 incorporating, by way of example for purposes of illustrating this embodiment, eight pixel compositor devices labeled 10a-10h adapted to accept 16 inputs/input devices and 16 output devices (i.e., n=16).

FIG. 3 is a high level functional sketch summarizing an alternative mean 230 for interconnecting levels|tiers|columns of pixel compositor devices for routing pixel information from a rendering cluster of devices (e.g., labeled Level 0, at left) and through compositor devices (center column) interconnected for routing pixel information therebetween, and on to another bank of devices or projectors (far right column). See, also, FIG. 2 at 200.

FIG. 4 is a diagram representing data flow through a compositor device such as 10, 100 in the form of a preferred alternative embodiment.

FIG. 5 is an arbiter state machine state diagram representing a preferred alternative approach to reading from input FIFO's and writing to buffers, as represented and labeled in FIG. 4.

FIG. 6 is a flow chart highlighting the unique nature of core as well as additional and alternative features of a method 600 utilizing a pixel compositor device.

FIGS. 7, 8A-8B schematically depict alternative overall strategies for implementing certain features, e.g., pixel mapping, of system 200 and method 600.

### DESCRIPTION DETAILING FEATURES OF THE INVENTION

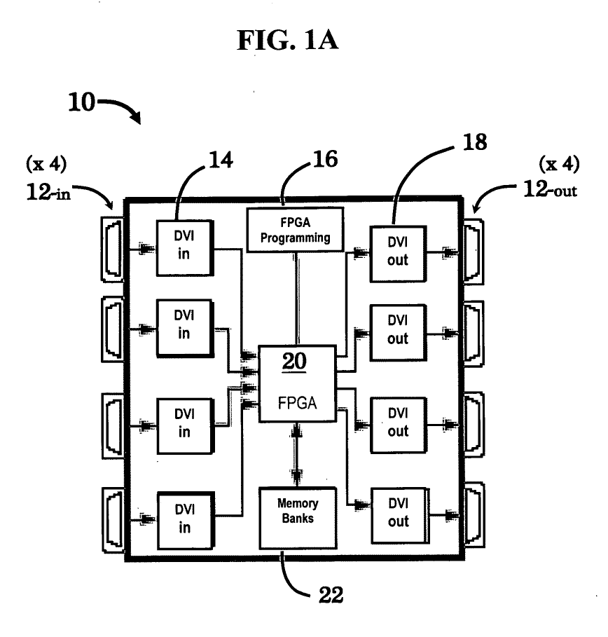

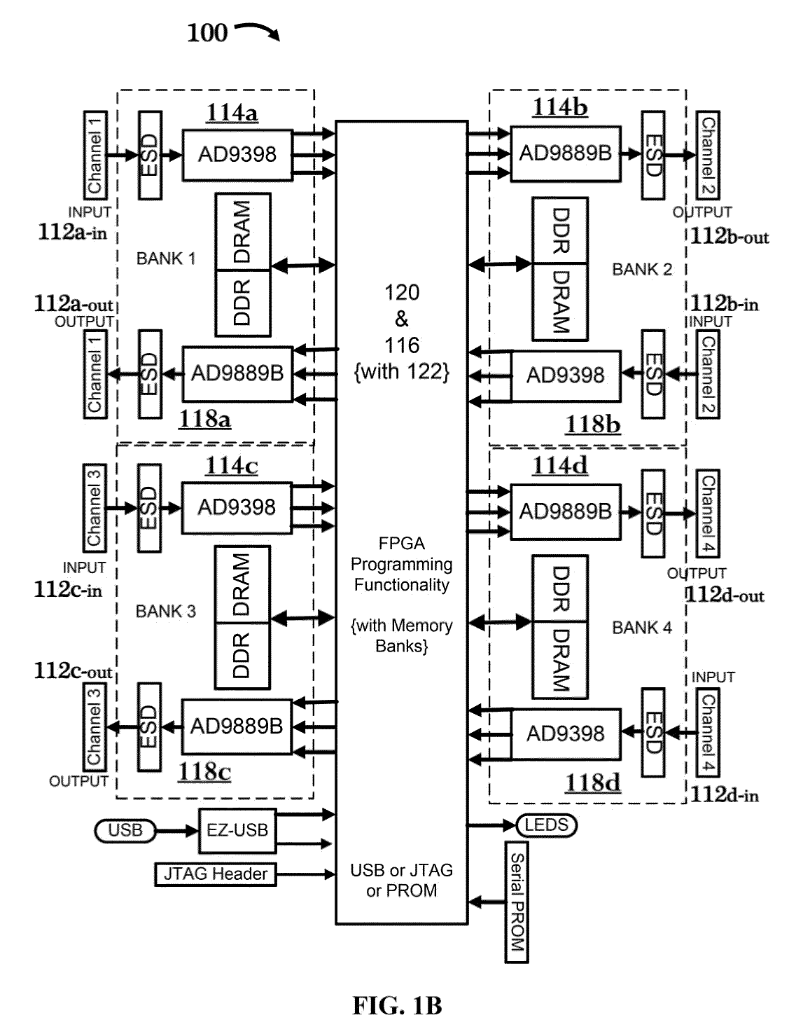

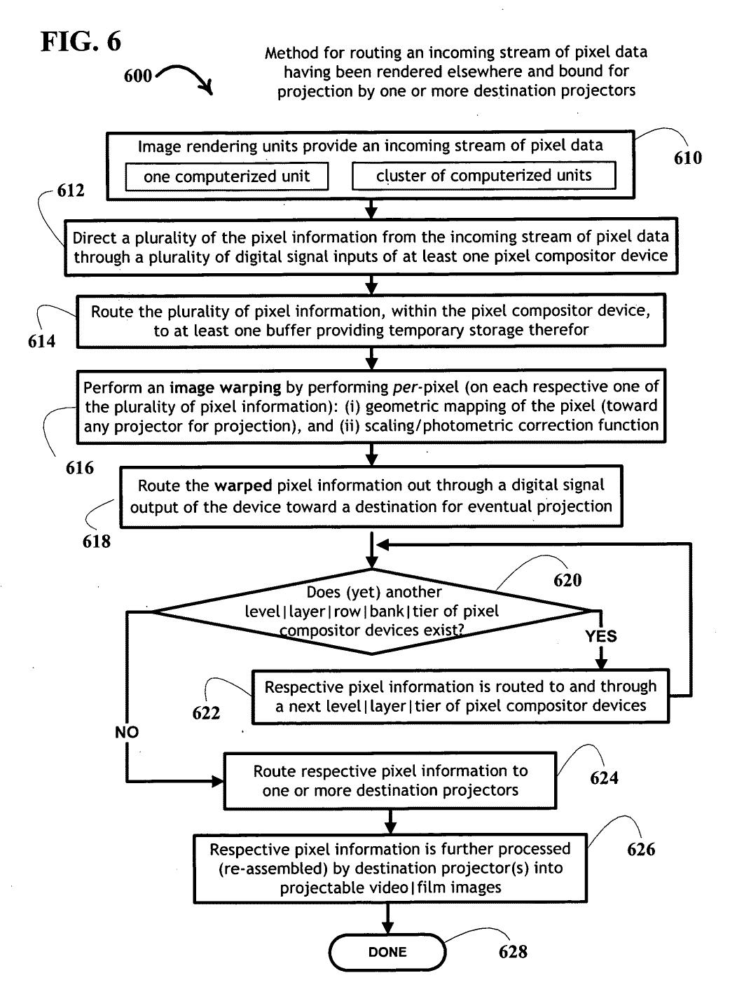

By viewing the figures which depict and associate representative structural and functional embodiments, one can further appreciate the unique nature of core as well as additional and alternative features of the new pixel compositor device, cluster system 200 and associated technique/method 600. Back-and-forth reference has been made to the various drawings-especially the schematic diagrams of FIGS. 1A, 1B, 2-4, and the method in FIG. 6, which collectively detail core as well as additional features of the device, system, and method. This type of back-and-forth reference is done to associate respective features (whether primarily structural or functional in nature) having commonality, providing a better overall appreciation of the unique nature of the device, system, and method.

When building multi-projector systems using currently-available devices, complex software-compatibility issues often arise in connection with implementing multi-projector displays. The innovation contemplated herein is directed to a unique pixel compositor device that bridges the image generator (e.g., an image rendering cluster) and the projectors. The unique ‘universal’ (hence, the term ‘anywhere’ has been coined by applicants) pixel compositor 10 is capable of performing—on a per-pixel basis—an ‘arbitrary’ mapping of pixels from an input frame to an output frame, along with executing typical composition operations (e.g., scaling functions such as the photometric correction functions known as alpha-blending, color uniformity correction, and other such conventional image adjustment/warping, including brightness and contrast) prior to routing the pixel information elsewhere. That is to say, image warping by the new device 10, 10a-h, 100, 400, 600 is performed on each of a respective one of the pixel information/data of an incoming stream of image data by performing both: (i) a mapping relating to location of the respective pixel information, and (ii) a scaling function (for example, see FIG. 6 at step 616).

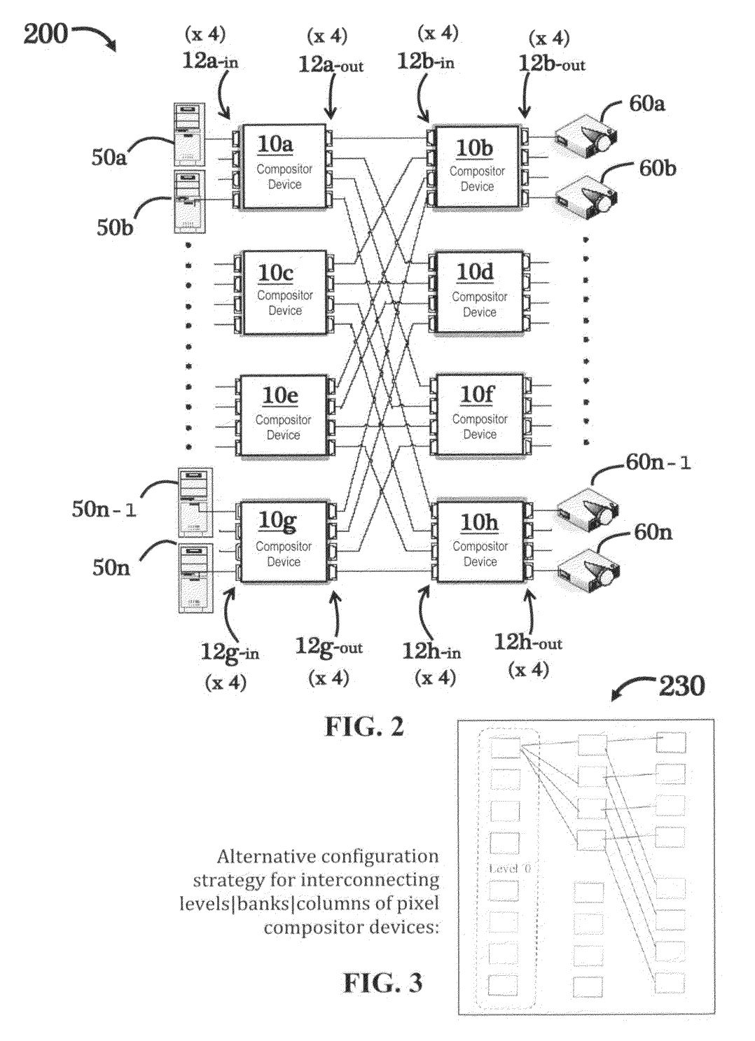

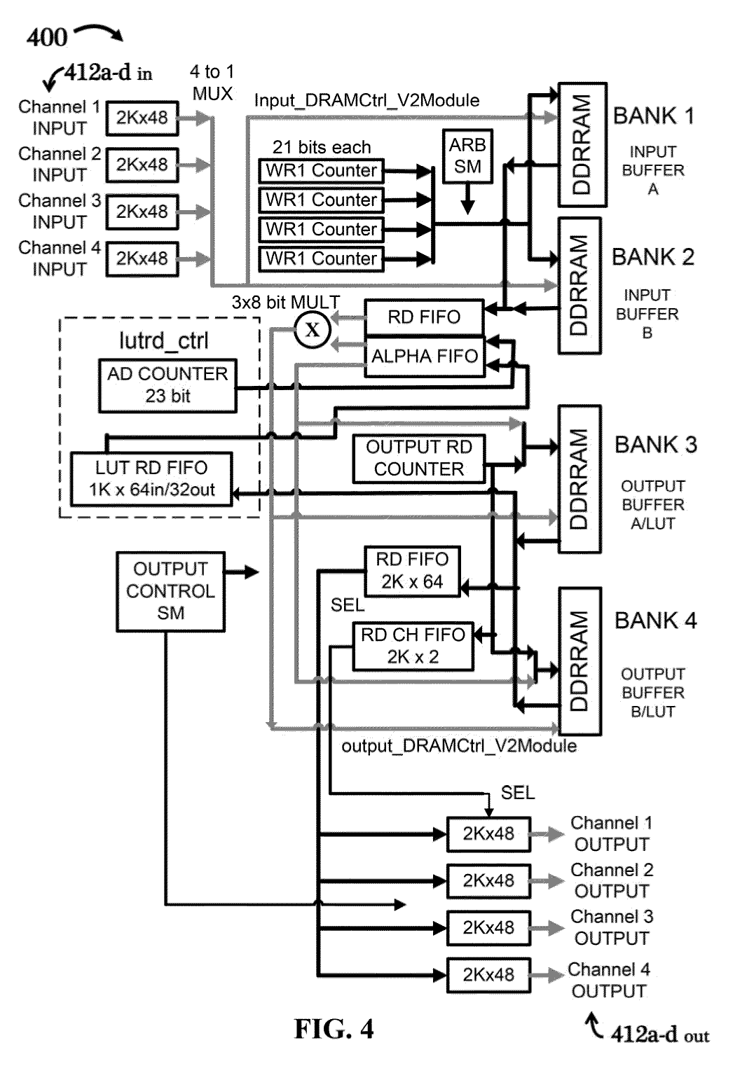

As an unit, effectively, ‘independent’ of system hardware/components, the new pixel compositor device 10 (FIG. 1A), 10a-h (FIG. 2), 100 (FIG. 1B), 400 (FIG. 4) permits a single computerized processor (such as is found in a PC, personal computer) to control multiple projectors and produce projected images onto a flat or curved surface, or piecewise-linear screen. While more than one computerized processor may be used (50a-50n in FIG. 2—but not limited to—up to n=16 inputs from a variety of computer processing devices may be accommodated), one PC processing unit is sufficient to produce a projected display if in electrical communication with the new pixel compositor 10 (FIG. 1A), 10a-h (FIG. 2), 100 (FIG. 1B), 400 (FIG. 4).

FIG. 1A is a high-level schematic of core features of the pixel compositor device 10. FIG. 1B is a block diagram detailing components of an alternative preferred device 100 (such as that further outlined below EXAMPLE 01) of the pixel compositor device 10, FIG. 1A. The data flow through compositor 10, 100 is depicted in a diagram FIG. 4, 400. The pixels may be transmitted digitally into and out of a device via an industry standard HDMI-to-DVI link/connections (for example, represented generally at 14, 18 in FIGS. 1A and 114a-d, 118a-d in FIG. 1B). As labeled, respectively, four 12-in, connections accept incoming pixel data from individual image generation sources (not shown, for simplicity, see FIG. 2 at 50a-n) and four, 12-out DVI link/connection(s) send mapped pixel information out of device 10. See, also, method 600 in FIG. 6 at steps 610 and 612. The core mapping and arithmetic operations are preferably carried out by a programmable IC chip such as that labeled FPGA at 20, 120 (associated programming functionality are at 16, 116).

IC chip 20, 120 is connected to at least one sufficiently-large sized memory bank(s) 22, 122 for storing both the pixel mapping information and temporary frames (as necessary). See, also, method 600, FIG. 6 at step 614 and data flow diagram 400, FIG. 4 (the input image information is preferably buffered BANK 1/INPUT BUFFER A and BANK 2/INPUT BUFFER B). A preferred pixel compositor unit 10, 10a-h, 100 has four input links and four outputs, respectively represented as follows: 12-in, 12-out (FIG. 1A); 12a-in through 12h-in, 12a-out through 12h-out (FIG. 2); and 112a-in through 112d-in, 112a-out through 112h-out (FIG. 1B). See, also, data flow diagram 400 in FIG. 4: four input channels for receiving pixel data streams are represented at 412a-d in and the output channels at 412a-d out. Multiple units can be arranged in a network to achieve the scalability for large clusters: FIG. 3 depicts an example configuration to composite a plurality (e.g., in this cluster, n=16) of DVI streams out respective devices 10b, 10d, 10f, 10h and into projector units labeled 60a-60n. See, also, FIG. 3 illustrating an interconnection strategy between PC's and one or more layer of the unique devices and/or projector bank.

FIG. 2 is a high-level schematic depicting features of a preferred system 200 incorporating, by way of example for purposes of illustrating this system, two banks or columns with a total of eight pixel compositor devices labeled 10a-10h adapted to accept 16 inputs/input computerized units (respectively, image rendering units are labeled 50a-50n). As configured, the second bank/tier of devices 10b, 10d, 10f, 10h have a total of 16 outputs 12b-hout to the projectors (respectively labeled 60a-60n, here, n=16). The unique system configuration 200, using just eight devices 10a-10h functioning utilizing the unique per-pixel routing technique 600, FIG. 6, permits a huge amount of rendered video/film content from 50a-50n to be efficiently, timely projected with a large multi-projector projection system 60a-60n.

FIG. 3 is a high level functional sketch summarizing an alternative mean 230 for interconnecting levels|tiers|columns of pixel compositor devices for routing pixel information from a rendering cluster of devices (e.g., labeled Level 0, at left of sketch) and through compositor devices (center column) interconnected for routing pixel information therebetween, and on to another bank of devices or projectors (far right column). See, also, FIG. 2 at 200.

As mentioned elsewhere, the unique ‘universal’ (hence, the term ‘anywhere’ has been coined by applicants) pixel compositor 10, 100 is capable of performing—on a per-pixel basis—an ‘arbitrary’ mapping of pixels from an input frame to an output frame, along with executing typical composition operations (e.g., scaling functions such as the photometric correction functions known as alpha-blending, color uniformity correction, and other such conventional image adjustment/warping, including brightness and contrast) prior to routing the pixel information elsewhere. That is to say, image warping by the new device 10, 10a-h, 100, 400 is performed on each of a respective one of the pixel information/data of an incoming stream of image data by performing both: (i) a mapping relating to location of the respective pixel information, and (ii) a scaling function. FIG. 6 is a flow chart highlighting the unique nature of core as well as additional and alternative features of method 600 utilizing a pixel compositor device.

The method for routing an incoming stream of pixel data having been rendered elsewhere and bound for projection by one or more destination projectors 600, utilizes an incoming stream of pixel data having been rendered by one or more computerized units 610. A plurality of the pixel information (pixels) from the incoming stream of pixel data is directed through a plurality of digital signal inputs of at least one pixel compositor device 612. The pixel information can be directed/routed within the device to at least one buffer providing temporary storage 614. An image warping is performed per-pixel (on each respective one of the plurality of pixel information) by performing: (i) geometric mapping of the pixel (such that the respective pixel information is adapted for routing toward any projector for projection), and (ii) scaling/photometric correction function 616. The warped pixel information is sent out the device through a digital signal output 618. If there are no other tiers/banks (e.g., 10b, 10d, 10f, 10h, FIG. 2) through which the pixel information is directed 620 to 624, the pixel information is routed to its destination projector for reassembly into a projectable video|film 626. If the system is configured with additional levels/tiers of devices 620 to 622, routing continues through the tiers until the pixel information reaches a destination bank of projectors.

In connection with step 616(i): The pixel routing technique of inverse mapping for image transformation can preferably be employed by the compositor device 10, 100 to minimize ‘holes’ in output (see ATTACHMENT 01 for further explanation of inverse/backward mapping of pixels). Texture mapping is a graphic design process, or tool, in which a two-dimensional (2D) surface, called a texture map, is digitally ‘painted onto’ or ‘wrapped around’ a three-dimensional (3D) computer-generated graphic so that the 3D object acquires a surface texture similar to that of the 2D surface. A texture map is applied (‘mapped’) to the surface of a shape, or polygon. A texel is a texture pixel, or a pixel that also includes texture information. One quick method for routing or mapping pixels is to use nearest-neighbor interpolation; two commonly used alternatives to nearest-neighbor interpolation that can reduce aliasing are bilinear interpolation or trilinear interpolation between mipmaps. Nearest-neighbor interpolation (in some context, proximal interpolation or point sampling) is a simple method of multivariate interpolation in one or more dimensions. Interpolation is the problem of approximating the value for a non-given point in some space, when given some values of points around that point. The nearest neighbor algorithm simply selects the value of the nearest point, and does not consider the values of other neighboring points, yielding a piecewise-constant interpolant. The algorithm is simple to implement, and is used (usually along with mipmapping) in real-time 3D rendering to select color values for a textured surface (however, it gives the roughest quality). Bilinear interpolation is an extension of the linear interpolation technique for interpolating functions of two variables on a regular grid: A linear interpolation is first performed in one direction, and then again in the other direction. Trilinear interpolation is the extension of linear interpolation, which operates in spaces with dimension D=1, and bilinear interpolation, which operates with dimension D=2, to dimension D=3.

In addition to being employed to produce multi-projector displays, the new device represented at 10, 100, 400 can be used in connection with the following:

(a) auto-stereoscopic (multi-view) displays, in particular lenticular-based displays. This type of 3D-displays display many views simultaneously and therefore require orders of magnitude more pixels to provide an observer adequate resolution. This can be achieved with a rendering cluster.

(b) distributed general-purpose computing on graphics processor units (GPGPU), as the instant invention provides the random write capability missing in most current graphics hardware. By providing a scalable and flexible link among a cluster of GPUs, the new pixel compositor devices can efficiently work in concert to solve problems, both graphical and non-graphical, on a much larger scale.

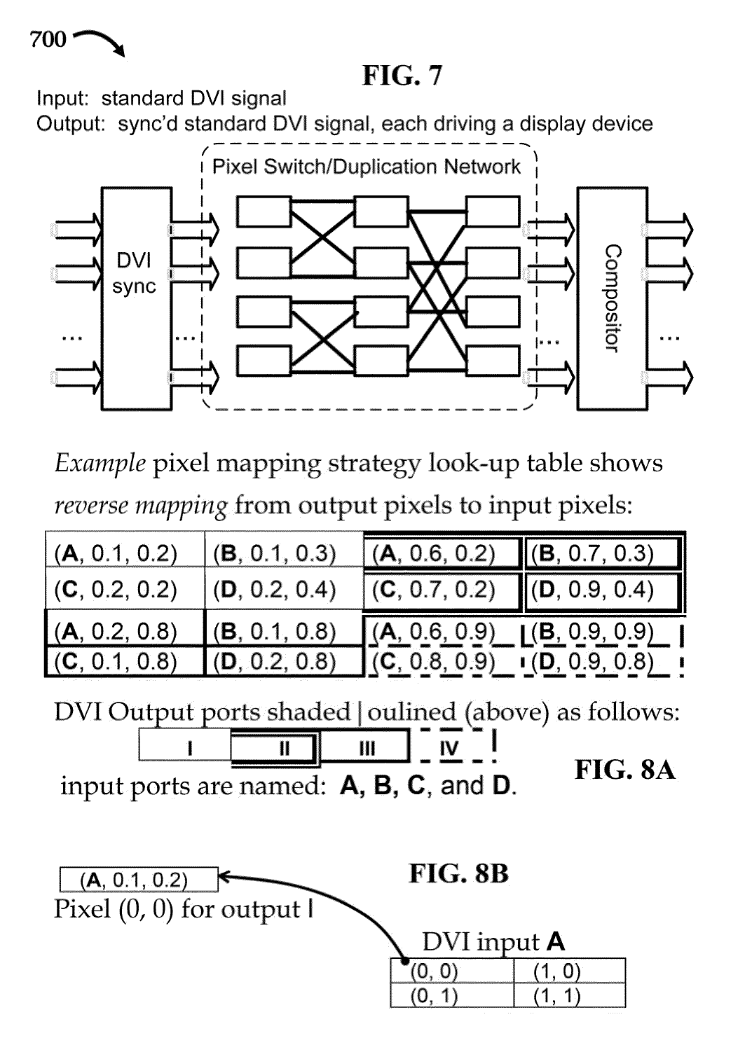

FIGS. 7, 8A-8B represent alternative overall strategies for implementing certain features, e.g., pixel mapping, of system 200 and method 600. Sketched in FIG. 3, is one strategy for networking nodes for a 32-projector system; in connection therewith, the table below offers some options for network topologies based on total number n of projectors used (FIG. 2, 60a-n):

TABLE A
Options for associated Network Topologies
based on number of projectors

| # of projectors | # of boxes | # of layers | # of DVI cables |
|---|---|---|---|
| 4 (2²) | 1 | 1 | 4 |
| 8 (2³) | 2 | 2 | 4 + 8 |
| 16 (4²) | 8 | 2 | 32 |
| 32 (2⁵) | 24 | 3 | 8*4 + 8*2 + 8*4 |
| 64 (4³) | 64/4*3 = 48 | 3 | 16*4*3 = 64*3 = 192 |
| 4ⁿ | 2⁽²ⁿ⁻²⁾*(n) | n | n*4ⁿ |

In connection with FIG. 7, initial issues to address include: scheduling and buffering.

TABLE 1
Simple Routing Scheme

| | Input DVI (queue) | | | Output DVI | | | |
|---|---|---|---|---|---|---|---|
| Tick | 0 | 1 | 2 | 0 | 1 | 2 | 3 |
| 0 | P0 | Q0 | R0 | | | | |
| 1 | P0, P1 | Q1 | R0, R1 | P0 | Q0 | R0 | R0 |
| 2 | P1, P2 | Q1, Q2 | R0, R1, R2 | R0 | P0 | XX | P0 |
| 3 | P1, P2, P3 | Q1, Q2, Q3 | R1, R2, R3 | XX | R0 | XX | XX |
| 4 | | | | | | | |

One possibility is to use a timing scheme shown in the above table. P, Q, R with subscripts are the pixels for input DVI port 0, 1, and 2. The subscript is the index of the clock tick. This scheme is relative simple to implement, but it slows down the entire system to the maximum # of output conflicts and therefore may have a large latency (and buffering requirement). It also assumes that one input can be routed to multiple outputs in a single cycle (which seems to be a reasonable assumption).

Three key functional units, as labeled in the FIG. 7 functional diagram include:
(1) DVI Sync block: To buffer and synchronize all DVI streams.
(2) Pixel switch network: preferably a butterfly network used to route pixels to different DVI downstream; new DVI timing scheme; plus central clock is used to synchronize all operations.
(3) Compositor device: One guide, by way of example, for pixel mapping is shown and labeled FIGS. 8A and 8B.

### Example 01

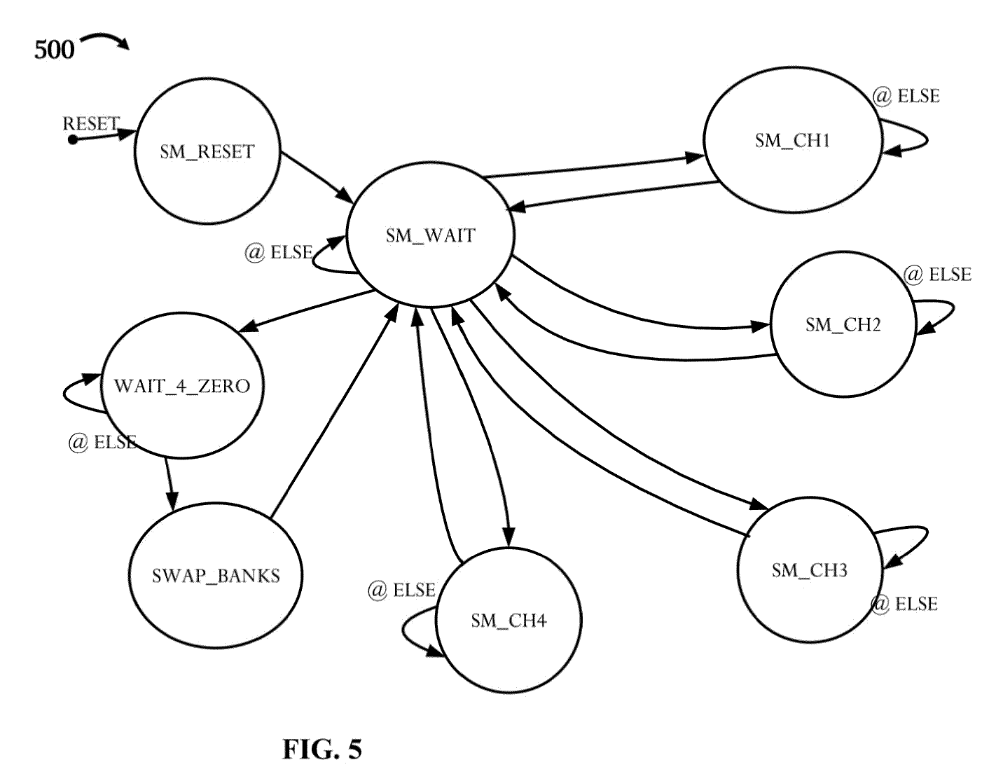

FIG. 4 is a diagram representing data flow through a compositor device such as 10, 100 in the form of a preferred alternative embodiment. FIG. 5 is an arbiter state machine state diagram representing a preferred alternative approach to reading from input FIFO's and writing to buffers, as represented and labeled in FIG. 4. Core, as well as further distinguishing features of FIGS. 4 and 5 (and others), have been woven together in this EXAMPLE 01, by way of example only, providing details of device and system components—and associated functionalities—to further illustrate the unique nature of pixel compositor device and method 10, 10a-h, 100, 400, 600.

A Xilinx VIRTEX-4 FPGA core, 256 MB of DDR RAM arranged on four independent buses, and 4 HDMI inputs and 4 HDMI outputs. The HDMI interface is backward compatible with the DVI interface. The FPGA core can be run at 200 MHz. The input image information is preferably buffered (INPUT BUFFER A and B, FIG. 4). To achieve a target operation at 1024×768@60 Hz (many projectors operate at this mode), a minimum bandwidth of 1.7 GB/s is preferably sustained, which includes at least a read, a write, and a table look-up operation at each pixel tick. Unlike traditional composition tasks that have sound data locality, the new device 10 preferably employs a look-up table-based mapping. As far as operational ranges: the instant device preferably sustains 30 Hz update in worst-case scenario, i.e., cache miss all the time, and for cache hit all the time, it preferably operates at over 60 Hz.

By way of example as explained in this example embodiment, the device 100 has been fabricated maintain an update rate of 30 frames/second (fps) at XGA (1024×768) resolution. The supported resolutions are from 1024×768 to 1920×1080. Multiple boards are synchronized via a “genlock” connector. The new device 100 can have a maximum latency of 2 frames at 30 fps. Compositor device circuitry 100 has four HDMI video inputs (DVI to HDMI converters may be used to support DVI if the circuitry natively support HDMI inputs), and performs arbitrary pixel mapping/routing and color scaling (alpha-blending) on the inputs on a per-pixel basis. The routing function may be stored as a look-up table (LUT) and the alpha-blending is stored as a mask. Both the LUT and the mask are user programmable via a USB 2.0 link (non real-time). The device 100 then sends the processed frames out four HDMI transmitters, 112a-dout (FIG. 1B) and 412a-dout (FIG. 4). Several compositor devices 10a-10h (FIG. 2) may be arranged in a network to achieve scalability for large clusters. The supported resolutions are from 1024×768 to 1920×1080. Multiple boards are synchronized via a “genlock” connector.

1. HDMI Input

The device 100 (FIG. 1B) is shown with four HDMI inputs that may be converted to DVI with use of an external adapter cable. The inputs use the standard HDMI “Type A” 19-pin connector and then go through a California Microdevices ESD protection IC (CM2020) and then on to the Analog Devices AD9398 receiver. The CM2020 provides ESD protection for the AD9398 receiver. The AD9398 receives the HDMI signals which consist of: 3 TDMS (Transition Minimized Differential Signaling) data signals, a TDMS clock, and the Display Data Channel (DDC) which is used for configuration and status exchange across the HDMI link. The AD9398 HDMI receiver takes this input and outputs 3 eight bit buses: BLUE, GREEN and RED along with strobes that are connected to the FPGA. There is a two wire serial communication path to the AD9398 from the FPGA to allow setup of parameters and operation modes, which is normally only done on power-up.

2. HDMI Output

The device 100 is shown with four HDMI outputs that may be converted to DVI with use of an external adapter cable. The outputs are sources from the FPGA and consist of three busses: BLUE, GREEN and RED along with strobes that connect to a AD9889B HMDI transmitter. There is a two wire serial communication path to the AD9889B from the FPGA to allow programming of parameters and operation modes, which is normally only done on power-up. The serial output from the transmitter then goes through a California Microdevices ESD protection IC and then on to the standard HDMI “Type A” 19 pin connector.

3. USB Interface

The USB interface (“EZ-USB”) provides setup of modes and registers, programming of the lookup tables and programming of the FPGA. The USB port supports hi-speed USB transfers (up to 54 MB/sec) to/from the FPGA. The high speed FPGA interface is a 16 bit data/address parallel interface that provides high speed block data transfers.

4. DDR DRAM Description

There are four independent banks of 32 Meg×32 bit DDR SDRAM shown. The device can be designed to allow increases in the depth of the DRAM by substituting other DRAMs and also will allow different standard DRAMs to be used. Any changes to the DRAM populated will re-quire an FPGA re-compile. The connection to the FPGA is made to optimize flow through each of the HDMI receivers to the DRAM and then out though the HDMI transmitters.

5. FPGA

The overall function of the device circuitry is to perform image warping, this is implemented in the FPGA. Like most modern graphics systems, double-buffering is used, i.e., the system stores at least two frames per HDMI/DVI output stream at any given time. One is used for scan-out and the other is used as a working buffer for the next frame. The functions of the two buffers are ping-pong back and forth. The image warping has been decomposed into two functions, basically mapping and scaling. The FPGA also interfaces the other components and provides programming and setup. The FPGA configuration is stored on an on-board serial PROM which may be re-programmed using a cable. FIG. 4 shows the image data flow.

6. Input FIFOs/Buffer Control Logic

The Input FIFOs are four 2K×48 bit FIFOs which provide storage for input scan line data for the four input channels. Data is written to the FIFOs at the pixel clock frequency (independent for each channel). Buffer Control logic controls the reads data from the input FIFOs and writes it to the INPUT BUFFER DRAMs. There are two Input buffers set up as a Ping Pong buffer and while data is written to one it is read from the other. The control of the reading of the input FIFOs is done via the Arbiter State Machine (FIG. 5 at 500). If there is too much image data coming (ie FIFO overflow) the contents of the FIFOs will be flushed and the control logic will wait (i.e. skip a frame) until the next Vertical Sync.

7. Arbiter State Machine (FIG. 5)

The Arbitor State Machine controls the reads from the input FIFOs and the random reads from the INPUT BUFFERS. The arbiter can use a round robin approach to enable each input channel. RD_XFERSIZE_TC and INXFERSZ_TC are generated from the counters loaded with the Transfer Size Register values multiplied by four. There is a flag (FLAG RD_DONE) that is set when an entire frame has been read. Once a read of RDXFERSZ pixels has been done if there is data available in the channel 1 input FIFO that is written to the DRAM, else channel 2 is checked etc.

8. LUT-based Pixel Routing

The Xilinx FPGA implements an inverse mapping (also known as backward mapping, see ATTACHMENT 01 (six pages for a graphical explanation). In an inverse mapping, for every pixel (x,y) in the output buffer, find its position (u,v) in the input image, and copy the pixel from that (u,v) location. In our implementation, instead of computing the location, we store the location in a look-up table. Implementation can utilize nearest-neighbor interpolation which gives a basic level of quality. Alternatively, higher quality may be achieved by using bilinear interpolation (en.wikipedia.org/wiki/Bilinear_interpolation for details) or trilinear interpolation, at cost of increased bandwidth and memory requirement, since [u,v] needs to be represented with fractional address.

For (int y = 0; y< imageHeight; y++)

For (int x = 0; x< imageWidth; x++) {

[u,v] = LUT(x,y); / / retrieve the source pixel

address

I_out(x,y) = I_in(u,v)

}

9. Alpha-Blending (Weighting)

The mapped pixels are next “blended”. That is, the pixel from the input image is multiplied by a scale factor. The scale factor, which can vary from pixel to pixel, is between 0 and 1, and typically stored with 8 bits. The per-pixel weight is stored again in a look-up table, which is usually called the alpha mask.

To combine alpha blending with image warping, the code above can be changed to:

For (int y = 0; y< imageHeight; y++)

For (int x = 0; x< imageWidth; x++) {

[u,v, alpha] = LUT(x,y);
/ / retrieve the source pixel address,
/ / as well as the alpha value

I_out(x,y) = I_in(u,v)*alpha;

}

To reduce memory access overhead, combine the alpha mask values with the LUT. The above code assumes such a layout. This increases the LUT cell size by another 8 bits. Note that the alpha mask may be reduced to 6 bits or even 4 bits, depending on the application.

10. Memory Interface

The DRAM setup, interface and control is done via a Xilinx IP core generated via the Xilinx Memory Interface Generator (MIG). The DRAM is programmed to use 2.5 CAS latency, a burst length of 2 and a clock speed of 133/266 MHZ DDR. These parameters may be changed but require a re-compile.

11. HMDI Input/Output Programming Interface

The HMDI receiver and transmitters on the board utilize a two-wire serial programming interface which is controlled via the FPGA. The setup of the four AD9398 HDMI receivers and four AD9889B HDMI transmitters is normally done with an external two wire PROM. In the Pixel Router design this prom is integrated into the FPGA fabric to allow changing of parameters with a FPGA design re-compile.

12. USB Controller Interface

The USB controller is used to download the LUT table, setup the board and optionally download the bitstream during debug. The registers and memory interface FIFO are suitably memory mapped. The interface to the FPGA can utilize the EZ-USB Controller high speed parallel port interface. When doing data burst transfers there must be a least one command transfer between each data burst.

13. Look-up tables

The first thing done upon powering up the device circuitry 100, 400 is loading the LUTs (Look Up Tables). The LUTs are specially generated .TXT files that provide the warping information utilized by the hardware. In the upper right dialog boxes the LUT files are selected and if the check box is checked they are downloaded to the hardware. Once the LUTs are selected the “Load” button is selected and the LUTs are written. The board must be in “Standby” mode to write LUTs and the software will set it to this mode. Some LUT should be written at least one when the system is powered on, otherwise random data in the memory may become a problem for other channels. If a channel is not to be used load a 1 to 1 LUT to minimize performance impact.

While certain representative embodiments and details have been shown for the purpose of illustrating features of the invention, those skilled in the art will readily appreciate that various modifications, whether specifically or expressly identified herein, may be made to these representative embodiments without departing from the novel core teachings or scope of this technical disclosure. Accordingly, all such modifications are intended to be included within the scope of the claims. Although the commonly employed preamble phrase “comprising the steps of” may be used herein, or hereafter, in a method claim, the applicants do not intend to invoke 35 U.S.C. §112 ¶6 in a manner that unduly limits rights to their innovation. Furthermore, in any claim that is filed herewith or hereafter, any means-plus-function clauses used, or later found to be present, are intended to cover at least all structure(s) described herein as performing the recited function and not only structural equivalents but also equivalent structures.

We claim:

1. A pixel compositor device for routing an incoming stream of pixel data having been rendered elsewhere and bound for being projected, the device comprising:
(a) a plurality of digital signal inputs each adapted for receiving a plurality of pixel information from the incoming stream of pixel data;
(b) said plurality of digital signal inputs in communication with at least one buffer to which said plurality of pixel information may be directed once received by the device;
(c) a processing unit for image warping said pixel information by performing, on each of a respective one of said plurality of pixel information: (i) a mapping relating to location of said respective pixel information, and (ii) a scaling function; and
(d) a plurality of digital signal outputs through which said respective pixel information, once said image warping has been performed thereon, is routed out of the device.

2. The pixel compositor device of claim 1, wherein:
(a) said plurality of digital signal inputs also in communication with a second buffer providing temporary storage for said plurality of pixel information once received;
(b) said mapping is a geometric mapping implemented by applying an interpolation technique; and
(c) said scaling function comprises a photometric correction function.

3. The pixel compositor device of claim 2:
(a) further comprising a second one of the pixel compositor device, both of the first and second pixel compositor devices in communication with at least one computerized unit for rendering video images and a projector; and
(b) wherein said photometric correction function is selected from the group consisting of: an alpha-blending carried out by applying a per-pixel scale factor to each said pixel information, a color uniformity correction, an image brightness adjustment, and an image contrast adjustment.

4. The pixel compositor device of claim 1:
(a) further comprising an input memory dedicated to each of said plurality of digital signal inputs; and
(b) wherein said plurality of digital signal inputs comprises four separate inputs, and said plurality of digital signal outputs comprises four separate outputs.

5. The pixel compositor device of claim 4 in communication with at least one computerized unit for rendering video images and a plurality of projectors, wherein:
(a) each said input memory operates in a First-in-First-Out manner upon receiving said pixel information from said at least one computerized unit; and
(b) each one of said plurality of projectors is in communication with a respective one of said four digital signal outputs.

6. The pixel compositor device of claim 5, wherein:
(a) said at least one computerized unit is a member of an image rendering cluster of computerized units;
(b) said mapping is a geometric mapping implemented by applying an interpolation technique selected from the group consisting of nearest-neighbor interpolation, bilinear interpolation, and trilinear interpolation; and
(c) said scaling function comprises a photometric correction function selected from the group consisting of: an alpha-blending carried out by applying a per-pixel scale factor to each said pixel information, a color uniformity correction, an image brightness adjustment, and an image contrast adjustment.

7. A pixel compositor device for routing an incoming stream of pixel data having been rendered by at least one computerized unit and bound for being projected from a plurality of projectors, the device comprising:
(a) a plurality of digital signal inputs each adapted for receiving a plurality of pixel information from the incoming stream of pixel data;
(b) a processing unit for image warping said pixel information by performing, on each of a respective one of said plurality of pixel information: (i) a mapping relating to location of said respective pixel information, and (ii) a scaling function; and
(c) a plurality of digital signal outputs through which said respective pixel information, once said image warping has been performed thereon, is routed out of the device and on to the plurality of projectors.

8. The pixel compositor device of claim 7, wherein:
(a) the at least one computerized unit is a member of an image rendering cluster of computerized units;
(b) said mapping is a geometric mapping implemented by applying an interpolation technique; and
(c) said scaling function comprises a photometric correction function selected from the group consisting of: an alpha-blending carried out by applying a per-pixel scale factor to each said pixel information, a color uniformity correction, an image brightness adjustment, and an image contrast adjustment.

9. A second one of the pixel compositor device of claim 7, both of the first and second pixel compositor devices in communication with an image rendering cluster of computerized units, of which said at least one computerized unit is a member; and each of the pixel compositor devices further comprising an input memory dedicated to each of said plurality of digital signal inputs.

10. The pixel compositor devices of claim 9, wherein:
(a) each said input memory operates in a First-in-First-Out manner upon receiving said pixel information from said image rendering cluster of computerized units; and
(b) each one of said plurality of projectors is in communication with a respective one of said digital signal outputs.

11. A system for routing an incoming stream of pixel data having been rendered by at least one computerized unit and bound for being projected from a plurality of projectors, the system comprising at least a first and second pixel compositor device, each of the pixel compositor devices comprises:
(a) a plurality of digital signal inputs each adapted for receiving a plurality of pixel information from the incoming stream of pixel data;
(b) a processing unit for image warping said pixel information by performing, on each of a respective one of said plurality of pixel information: (i) a mapping relating to location of said respective pixel information, and (ii) a scaling function; and
(c) a plurality of digital signal outputs through which said respective pixel information, once said image warping has been performed thereon, is routed out and on to the plurality of projectors.

12. The system of claim 11, wherein:
(a) an input memory is dedicated to each of said plurality of digital signal inputs of each of the plurality of pixel compositor devices, each said input memory to operate in a First-in-First-Out manner upon receiving said pixel information;
(b) said mapping is a geometric mapping implemented by applying an interpolation technique; and
(c) said scaling function comprises a photometric correction function selected from the group consisting of: an alpha-blending carried out by applying a per-pixel scale factor to each said pixel information, a color uniformity correction, an image brightness adjustment, and an image contrast adjustment.

13. The system of claim 11, wherein:
(a) the at least one computerized unit is a member of an image rendering cluster of computerized units; and
(b) the first and second pixel compositor devices are in communication such that: a first of said plurality of digital signal outputs of said first device is in direct communication with a first of said plurality of digital signal inputs of said second device, so that said respective pixel information of said first device, once said image warping has been performed thereon, is routed to said second device for further routing prior to reaching one of the projectors.

14. The system of claim 13, further comprising:
(a) a third and fourth pixel compositor device; and
(b) said pixel compositor devices in communication such that:
a second of said plurality of digital signal outputs of said first device is in direct communication with a first of said plurality of digital signal inputs of said fourth device;
a first of said plurality of digital signal outputs of said third device is in direct communication with a second of said plurality of digital signal inputs of said second device; and
a second of said plurality of digital signal outputs of said third device is in direct communication with a second of said plurality of digital signal inputs of said fourth device.

15. A method for routing an incoming stream of pixel data having been rendered elsewhere and bound for being projected, the method comprising the steps of:
(a) receiving a plurality of pixel information from the incoming stream of pixel data through a plurality of digital signal inputs of at least one pixel compositor device;
(b) directing said plurality of pixel information, within said device, to at least one buffer providing temporary storage therefor;
(c) performing an image warping on said pixel information by performing, on each of a respective one of said plurality of pixel information: (i) a mapping relating to location of said respective pixel information, and (ii) a scaling function; and
(d) routing said respective pixel information, once said image warping has been performed thereon, out of said device through a plurality of digital signal outputs.

16. The method of claim 15, wherein said step of performing an image warping on said pixel information further comprises:
(a) said mapping is a geometric mapping implemented by applying an interpolation technique; and
(b) said scaling function comprises a photometric correction function.

17. The method of claim 16, wherein:
(a) said interpolation technique is selected from the group consisting of nearest-neighbor interpolation, bilinear interpolation, and trilinear interpolation; and
(b) said photometric correction function is selected from the group consisting of: an alpha-blending carried out by applying a per-pixel scale factor to each said pixel information, a color uniformity correction, an image brightness adjustment, and an image contrast adjustment.

18. The method of claim 15, further comprising the steps of:
(a) providing an image rendering cluster of computerized units to render the incoming stream of pixel data;
(b) providing an input memory dedicated to each of said plurality of digital signal inputs, each said input memory to operate in a First-in-First-Out manner upon receiving said pixel information from said image rendering cluster of computerized units; and
(c) wherein said step of routing said respective pixel information, once said image warping has been performed thereon, out of said device comprises routing to and through a second pixel compositor device prior to being projected.

19. The method of claim 15, further comprising the steps of:
(a) providing a second, third, and fourth pixel compositor device, each adapted for receiving said plurality of pixel information from the incoming stream of pixel data through a plurality of digital signal inputs dedicated to each said second, third, and four device; and
(b) said third pixel compositor device adapted for performing an image warping by performing, on each of a respective one of said plurality of pixel information received by said third device: (i) a mapping relating to location of said respective pixel information, and (ii) a scaling function.

20. The method of claim 19:
(a) wherein said step of routing said respective pixel information, once said image warping has been performed thereon, out of said first device comprises routing to and through a second pixel compositor device prior to being projected; and
(b) further comprising the step of routing said respective pixel information, once said image warping has been performed thereon by said third device, out of said plurality of digital signal outputs of said third device and to and through said fourth device prior to being projected.
